(19) United States
(12) Patent Application Publication
(10) Pub. No.: US 2007/0200047 A1
(43) Pub. Date: Aug. 30, 2007

(54) EXPANDABLE REINFORCING MEMBER

(76) Inventor: STEVEN ROSENBERG, Succasunna, NJ (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/676,890

(22) Filed: Feb. 20, 2007

Related U.S. Application Data
(60) Provisional application No. 60/775,229, filed on Feb. 21, 2006.

(51) Int. Cl. F16M 13/00

(52) U.S. Cl. 248/570

(57) ABSTRACT

An expandable reinforcing member includes a first and a second member configured to move relative to each other and defining an interior cavity therebetween. An expandable material is inside the cavity. Upon activation, the expandable material expands and causes the first and second members to move relative to each other in a manner that reinforces a hollow structural member.

### CROSS-REFERENCE TO RELATED APPLICATIONS

This application is a nonprovisional of U.S. Provisional Application Ser. No. 60/775,229, entitled EXPANDABLE REINFORCING MEMBER, filed Feb. 21, 2006 which is hereby incorporated herein by reference in its entirety.

### TECHNICAL FIELD

The following disclosure describes an expandable reinforcing member, and more particularly, an expandable reinforcing member for reinforcing a cavity.

### BACKGROUND

In many structural applications, it is desirable to provide structural members that are light-weight and yet have high-strength characteristics. One method of achieving light-weight and high-strength structural members is to start with a hollow outer structural member and insert a light-weight reinforcing member inside of the hollow structural member. One exemplary industry where such approach is well-known is the automotive industry, wherein a vehicle frame has several reinforced hollow structural members, such as hollow pillars and rails throughout the frame. Various reinforcing members are known, including those made from a substantially rigid member having structural expandable foam disposed on the outer peripheries of the rigid member for bonding the rigid member to the interior walls of the hollow structural member.

For ease of manufacturing, it is desirable that a reinforcing member be able to be used in various different types of hollow structural members and that the tolerances not be too stringent. Accordingly, there is a need for alternative reinforcing members, with improved reinforcing performance characteristics, which can be used in various sized hollow structural members.

### BRIEF DESCRIPTION OF THE DRAWINGS

The features and inventive aspects of the present invention will become more apparent from the following detailed description, the appended claims, and the accompanying drawings, in which:

FIG. 1 is a cross-sectional view of an expandable reinforcing member in an unexpanded orientation; and

FIG. 2 is a cross-sectional view of the expandable reinforcing member of FIG. 1 disposed inside a cavity in an expanded orientation.

### DETAILED DESCRIPTION

Referring now to the drawings, illustrative embodiments are shown in detail, Although the drawings represent the embodiments, the drawings are not necessarily to scale and certain features may be exaggerated to better illustrate and explain an innovative aspect of an embodiment. Further, the embodiments described herein are not intended to be exhaustive or otherwise limit or restrict the invention to the precise form and configuration shown in the drawings and disclosed in the following detailed description.

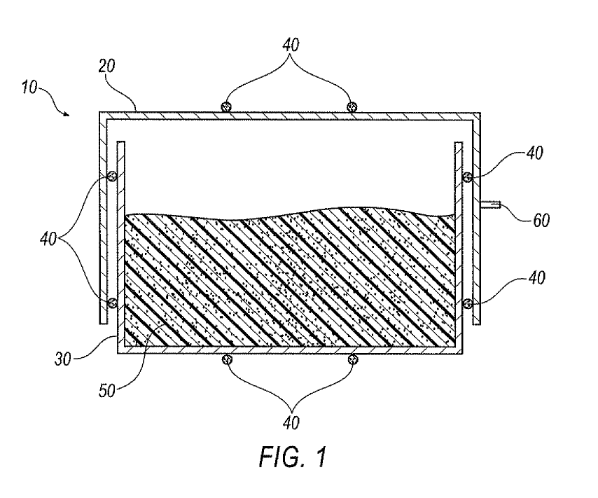

Referring now to FIG. 1, an expandable reinforcing member 10 is shown in an unexpanded orientation, The expandable reinforcing member 10 includes an inner member 30 at least partially disposed within an outer member 20. The inner member 30 and the outer member 20 may be of any shape, size, and material adapted for reinforcing a cavity in a structure. In one embodiment, the inner member 30 and outer member 20 are substantially rigid and made from a plastic, such as nylon. The inner member 30 is also adapted to fit at least partially within the outer member 20 so that at least a portion of one or more walls of the inner member 30 and the outer member 20 are generally adjacent. The inner member 30 and the outer member 20 together form a hollow interior cavity. An expandable material 50 is inside of the hollow interior cavity. In one embodiment, the expandable material 50 is an expandable structural or baffle foam, such as those described in U.S. Pat. No. 6,649,243, Pat. No. 6,387,470, Pat. No. 5,266,133, U.S. Pat. No. 6,348,513 and Pat. No. 5,373,027 and that are commercially available from Sika Corporation of Madison Heights, Mich. under the tradenames SIKABAFFLE 240 and SIKAREINFORCER 912.

A bonding material 40, such as an epoxy adhesive or, alternatively, additional expandable material may be placed at a first outer periphery of the outer member 20 and a second outer periphery of the inner member 30 to minimize movement between the expandable reinforcing member 10 and the hollow structural member (such as a vehicle rail or pillar) in the installed and expanded orientation. Further, the epoxy adhesive (40) may be placed between the inner walls of the outer member 20 and the outer walls of the inner member 30 to minimize movement between the inner member 30 and the outer member 20.

The expandable reinforcing member 10 is adapted to telescopically expand within the cavity or the hollow structure when an expanding agent, such as heat is applied thereto. In one embodiment, heat is applied to the expandable material when a vehicle is “baked” in a painting station during assembly. The first inner cavity of the outer member 20 shares at least a portion of the same space as the second inner cavity of the inner member 30 in the unexpanded orientation as shown in FIG. 1. The expandable material 50 is disposed within the first cavity and the second cavity and is adapted to bond the outer member 20 to the inner member 30 in the expanded orientation. The epoxy adhesive 40 may be formulated to cure at the temperature of an e-coat oven, typically used in the automobile assembly process. However, any adhesive 40 is contemplated. The expandable material 50 may expand at least twice its original volume. In one embodiment, the expandable material 50 is heat activated, such that expansion begins when heat is applied.

At least one attachment member 60 may be disposed anywhere on the outer periphery of the outer member 20, the inner member 30, or both. The attachment member 60 may be adapted to secure a portion of the expandable reinforcing member 10 to a predetermined location. The attachment member 60 may be secured to a wall of the hollow structural member to minimize the expandable reinforcing member 10 from moving from the predetermined location. In one embodiment, the attachment member 60 allows fixation of the assembly inside a hollow structure of an automobile pillar or rail.

One method of assembly will be described, However, other methods of assembling the expandable reinforcing member 10 are contemplated. The expandable reinforcing member 10 is assembled by first placing the expandable material 50 inside the inner volume of the smaller inner member 30. Adhesive or expandable material 40 is applied to the exterior walls of the inner member 30 and the outer member 20. Adhesive or expandable material 40 is then applied to the interior walls of the outer member 20 that are adjacent the outer walls of the inner member 30.

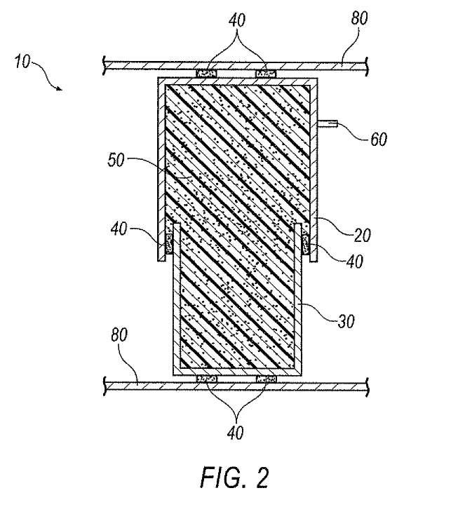

The outer member 20 is then placed over the inner member 30 and the entire assembly 10 is positioned inside the cavity or a section of the hollow structure. The expandable reinforcing member 10 may be secured to at least a portion of the cavity or hollow section of the structure by any securement method including fasteners, rivets, clamping, and the like. When heat is applied to the structure inside an oven, the expandable material 50 expands, telescoping the outer member 20 away from the inner member 30. The telescoping of the outer member 20 and the inner member 30 is sufficient to make contact with at least two walls 80 of the hollow structural member as shown in an expanded orientation in FIG. 2.

Once the expandable reinforcing structure 10 is in the expanded orientation, the adhesive 40 and the expandable material 50 cures and adheres to the contacted surfaces, thereby bonding the expandable reinforcing structure 10 to the walls 80 of the hollow structural member. Further, the epoxy adhesive 40 between the inner member 30 and the outer member 20 cure and minimize movement between the inner member 30 and the outer member 20. Once the expandable material 50 is cured, the expandable reinforcing member 10 adds significant structural strength to the hollow structural member.

If no adhesive 40 is used, the stiffness and strength of the cavity or hollow structure having a cured expandable reinforcing member 10 disposed therein depends on the strength of the expandable material 50 and the strength of the material used for the outer member 20 and the inner member 30. Adhesive 40 placed between the outer member 20 and the inner member 30, when cured, may add strength to the expandable reinforcing member 10.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed as new and desired to be protected by Letters Patent of the United States is:

1. An reinforcing member comprising:
a first member and a second member configured to be moveable relative to each other, said first and second members defining a substantially enclosed inner cavity; and
an expandable material contained within said cavity, said expandable material positioned so as to cause relative movement of said first and second members upon expansion.

2. The reinforcing member of claim 1, wherein said expandable material expands in response to the addition of an activating agent.

3. The reinforcing member of claim 2, wherein said activating agent is heat.

4. The reinforcing member of claim 1, wherein said expandable material expands to at least twice its original volume upon activation.

5. The reinforcing member of claim 1, wherein said first and second members are substantially rigid.

6. The reinforcing member of claim 1, wherein said second member is positioned substantially inside of said first member prior to expansion of said expandable material.

7. The reinforcing member of claim 1, where said expandable material is expandable foam.

8. The reinforcing member of claim 1, wherein:
said first member includes substantially parallel first and second outer walls and said second member includes substantially parallel first and second inner walls;
said first inner wall and said first outer wall forming a first channel therebetween, and said second inner wall and said second outer wall forming a second channel therebetween; and
a bonding material disposed in at least one of said first and second channels.

9. The reinforcing member of claim 8, wherein said bonding material is cured by heating.

10. The reinforcing member of claim 8, wherein said bonding material is chosen from the group of adhesives and expandable materials.

11. The reinforcing member of claim 1, further comprising a bonding material disposed on a periphery of said first member and said second member, said bonding material configured to bond said first and second members to walls of a reinforced structural member.

12. A reinforced structural member, comprising:
a hollow structural member having at least first and second walls;
a reinforcing member disposed inside of said hollow structural member, said reinforcing member including a first member and a second member, said second member being at least partially inside of said first member, and said first and second members together forming an interior substantially enclosed cavity; and
an expanded material disposed within and substantially filling said cavity.

13. The reinforced structural member of claim 12, further comprising bonding material between said first and second members to maintain said first and second members fixedly positioned relative to each other.

14. The reinforced structural member of claim 12, further comprising bonding material disposed between a periphery surface of said reinforcing member and at least said first wall of said hollow structural member.

15. The reinforced structural member of claim 12, wherein said expanded material is a structural foam.

16. A method of reinforcing a hollow structural member, comprising:
providing a reinforcing member having a first member and a second member, said first and second members being movable relative to each other, said first and second members defining a hollow cavity, an expandable material being disposed within said cavity; and
activating said expandable material, thereby causing said expandable material to expand, filling said cavity and generating relative movement between said first and second members until said first and second members are substantially abutting opposite walls of said hollow structural member.

17. The method of claim 16, further comprising the step of curing said expandable material.

18. The method of claim 16, further comprising the step of bonding a periphery of said reinforcing member to said hollow structural member.

19. The method of claim 16, further comprising the step of bonding said first member to said second member.
